(19) United States
(12) Patent Application Publication
(10) Pub. No.: US 2026/0210176 A1
(43) Pub. Date: Jul. 23, 2026

(54) Retrofit Window Energy Management System for Dynamic Control of Energy Flow Through Building Windows

(71) Applicant: The Mackinac Technology Company, Kentwood, MI (US)

(72) Inventors: John Thomas Slagter, Grand Rapids, MI (US); Attila Molnar, Vadnais Heights, MN (US); Anja Techel, Dresden (DE); David Tsu, Oro Valley, AZ (US)

(73) Assignee: The Mackinac Technology Company, Kentwood, MI (US)

(21) Appl. No.: 19/486,893

(22) PCT Filed: May 24, 2024
(86) PCT No.: PCT/US2024/031160

§ 371 Date: Feb. 11, 2026

Related U.S. Application Data
(60) Provisional application No. 63/468,743, filed on May 24, 2023.

(51) Int. Cl. E06B 9/264; E06B 9/24; F24S 20/63

(52) U.S. Cl. CPC E06B 9/264; F24S 20/63; E06B 2009/2417; E06B 2009/2643

(57) ABSTRACT

A retrofit window insulation system that achieves a very low solar heat gain coefficient (SHGC) of 0.10 or lower. The retrofit window insulation system is an ultra-lightweight, ultra-clear, low-e polymeric window cover that, in combination with solar screens and/or louvers that are mechanically deployable to offer optional shading for tunable control of daylighting and solar heating. Spectrally selective coatings on louvers which contain a phase change material (PCM) for thermal storage of daytime heat is particularly efficient. Placing a reflective film on the outward-facing surface of the louvers is reflective to sunlight but also emits thermal radiation back into the cold of space through the earth's atmosphere. If the louvers are placed between the retrofit window insulation system and the preexisting window glass, the air gap between the window and the retrofit window insulation system warms so that thermal energy is stored in the PCM.

### RELATIONSHIP TO OTHER APPLICATION

This application claims the benefit of the filing date of U.S. Provisional Patent Application Ser. No. 63/468,743 filed on May 24, 2023. The disclosure in this provisional patent application is incorporated herein by reference, in its entirety for all purposes.

### BACKGROUND OF THE INVENTION

### Field of the Invention

This invention relates generally to energy efficient windows and retrofit attachments, and more particularly to a dynamic shading system for tunable control of daylighting and solar heating.

### Description of the Prior Art

Secondary window attachments are a cost-effective and efficient way to improve thermal performance and occupant comfort as an alternative to replacing building windows. Secondary windows attach to the interior or exterior of an existing window frame or building wall and work by creating an insulating pocket of air between the existing window and new secondary window that significantly reduces air leakage and heat transfer resulting in significant energy savings.

Secondary window attachments are available in a variety of forms, such as storm windows, double and triple pane IGU-like units, rigid or suspended polymer films in frames, all of which provide varying degrees of insulation value and heat loss reduction.

The addition of a low emissivity (low-e) coatings to secondary window attachments is known to improve their function by minimizing the amount of ultraviolet and infrared light that can pass through the glass without compromising the amount of visible light that is transmitted.

As more effort is being invested into finding ways to lower greenhouse gas (GHG) emissions to mitigate global warming, energy efficiency is of paramount concern in the building trade. In order to optimize the energy efficiency of window systems, it is becoming increasingly important to have these systems operate dynamically so that they can respond to the ever-changing environmental conditions exterior to the building, including but not limited, to the daily changes in air temperature, and hourly changes in solar exposure due to a variety of factors including the earth's rotation, cloud cover, and the like.

In this regard, solar exposure leads to solar heating (SH) within the building. During the winter heating season, this SH acts as another source of internal energy (IE), like the presence of people, lighting energy, plugload energy, etc., that provides heat inside the building that the heating, ventilation, and air conditioning (HVAC) system of the building need not provide. This is beneficial in the winter heating season for reducing utility expense in operating the HVAC system. But, during the summer cooling season, the IE created by the sun (IEₛₒₗₐᵣ) adds heat inside of the building that the HVAC system needs to expel into the outside environment, thus increasing utility expense.

Energy cost is not the only consideration in how windows should function, occupant comfort and well-being are important, too. Too much natural lighting, such as when the sun shine directly through the windows, can cause an uncomfortable glare. Such glare must be controlled in all seasons. Traditionally, exposure to too much sun has been controlled by internal window treatments such as curtains, shades, venetian blinds, louvers, and the like. Window treatments also provide a modicum of insulation from exterior weather conditions.

When it comes to controlling energy use, the issue is not simply controlling the quantity of energy flow into the building, but controlling when this energy is used. In modern utility-wide grid delivery systems, controlling “peak load,” that is where during certain times of day, the demand is so high that the utility company needs to turn on other assets (e.g., its “peaking plant”) to meet demands is a major concern. The other assets are often more expensive to operate and have proportionately greater GHG emissions due to their inherent lower thermodynamic efficiency than the “base-plant” and the fact that they must respond quicky to the minute-by-minute variations of load. If the load during these peak demand periods can be “shifted” to non-peak times of day, then the overall efficiency of the grid will increase and GHG production will fall.

Incorporating phase change materials (PCMs) into building material for energy management is being actively considered as a way to store heat which can then be released later in the day or night after the peak demand period has passed. Some prior art secondary window attachments incorporate PCM-filled louvers in an effort to further improve their function. Louvers heat up when exposed to the sun's irradiant heating. While the louvers may block the sun's direct heating by transmission, the heat produced by absorption can easily flow into the interior of the building. This is a principle limitation that prevents lowering of the solar heat gain coefficient (SHGC). The solar heat gain coefficient (SHGC) is the fraction of solar radiation that enters a building though transparent windows or doors and ranges from 0 to 1. The lower the SHGC, the less heat transmission and the better heat insulation. It is a significant factor in the overall energy efficiency and thermal performance of a building.

In addition to “load shifting” from peak to non-peak times of day, simply lowering the load, referred to as “load shedding” is another strategy for increasing energy efficiency of the grid. During peak demand periods, lowering the overall load, allows the utility company to rely upon its base-plant for longer periods of time resulting in longer delays in turning on its peaking-plant. Since base-plants have higher inherent thermodynamic efficiency than peaking plants, they produce lower GHG emissions for the same quantity of delivered energy. Besides, lowering the base-load automatically lowers the GHG emissions since the Base/Peak plants will simply reduce their outputs.

For load shedding as it relates to windows, light-shelf and solar shading concepts have been proposed in the art. Light shelves, which are horizontal surfaces that reflects daylight onto the ceiling or deeper into the building space offset electric lighting thereby reducing electricity consumption. However, light shelves must be placed above eye-level. Other known concepts, such as PCM-filled louvers and solar shading are far from optimal, in their existing form, since their implementations are not designed at a system-wide level to take maximum advantage of their capabilities over widely varying climates zones, and even within any particular climate zone over the hourly changes in the weather/solar conditions.

The Mackinac Technology Company, Grand Rapids, MI (herein “Mackinac”) has developed energy efficient retrofit window attachments that it intends to market under the trademark WEMS™ for Window Energy Management Systems (herein referred to as “WEMS™ units”) that are capable of delivering >R-6 thermal insulation performance. The thermal insulation performance of the WEMS™ units can be improved to >R-7 when the unit has double-pane glazing.

To achieve this high thermal insulation, each WEMS™ unit comprises flexible low-e coated polymeric panes held taut by rigid frames. The polymeric panes are coated on at least one side, and preferably on both sides, so that a double-pane embodiment will have four coated surfaces. Since the low-e coating used by Mackinac has high transparency to visible light due to its anti-reflection design, the unit still maintains greater than 80% visible light transmittance. Advantageously, the low-e coating blocks nearly all ultraviolet and infrared heat energy, but is color neutral, transparent, and antireflective to visible light.

Despite the efficiency of the basic WEMS™ units, it would still be advantageous to provide dynamic control of the energy flow from the windows into the building and thereby impact both load shifting and load shedding components. This is especially important during the summer cooling season and in southern climates where the sensible heating is high, cloud cover is low, and solar heating is high, all of which product a significant burden on the HVAC.

### SUMMARY OF THE INVENTION

Mackinac has discovered that integration of solar shade (SS) fabrics, in the form of roller shade or screens, and/or louvers into Mackinac's low-e WEMS™ units, as will be described in greater detail hereinbelow, results in a far greater overall energy efficiency gain than by operating the louvers and/or shades alone or by using the WEMS™ units alone. As used herein, this combination is referred to as an “energy positive WEMS™ unit.” With only minor variations to accommodate for different climate zones, the energy positive WEMS™ unit of the present invention can be tuned to control the flow of energy in and out of the building to simultaneously have and impact on both load shedding and load shifting.

In accordance with the invention, a low-e WEMS™ unit in combination with shades, louvers, and the like, and preferably PCM-containing louvers, and more preferably PCM-containing louvers with light redirecting coatings, as will be described herein, is superior in performance and function to any known prior art combinations of primary and/or secondary window attachments incorporating, or used in conjunction with louvers, PCM-containing louvers, shades, blinds, or light shelves. The superior results achievable with the energy positive WEMS™ unit of the present invention is shown in Table 4 below which compares its efficiency with some known prior art secondary attachments, or retrofit window insulation systems.

The basic retrofit window insulation system, herein designated as a WEMS™ unit, has two primary components, the panes and the casing structure. The panes typically consist of glass, polymer film, or a combination of one or more layers of glass and/or polymer, one or more of the glass or polymer films having a low-e coating on at least one side, and preferably both sides, bonded or adhered to a rigid frame. In some instances, the rigid frame is installed in a casing structure, such as a stainless steel frame, that has grooves to support the pane or panes. A gasket can be used to create a porous seal around the perimeter of the unit. As a retrofit system, the entire unit is then installed in, or to, an existing window frame or wall either on the interior or the exterior of a building.

To achieve high thermal insulation performance, the WEMS™ unit uses the basic principles of the multilayer insulation used to protect spacecraft. Low-e surfaces applied to both sides of each polymer pane progressively reflect infrared heat energy so heat transfer is limited to conduction and convection through air, giving each air gap in the unit about the same R-value per inch of thickness as an inch of foam insulation. The gap spacing between the WEMS™ unit panes are carefully selected to optimize the lowest combined transport of radiation, conduction, and convection.

Double-pane WEMS™ units will add R-5 to the thermal insulation value of any existing glass window. Incorporating solar shade fabrics into the WEMS™ units will provide dynamically tunable control of the solar heat gain coefficient from SHGC 0.65 to SHGC 0.10. However, during testing, it was discovered that absorbed solar energy generated heat in the air gap between the glazing and the WEMS™ unit. In order to control the heat generated in the air gap between the glazing and the WEMS™ unit, coatings or fabrics of different tints, ranging from white to dark charcoal, can be applied to one or both sides of a shade or louver slat. In this example, the louvers can be rotated to expose either the dark or light side, or angled so that the desired side is exposed to only a portion of the sun's rays. In this manner the temperature of the air gaps can be effectively controlled.

In one specific example, a reflective tape or film is placed on the outward-facing side of louver slats that are placed between the WEMS™ unit and the existing window glass. This film can be a reflective tape or film, such as a metallized tape, illustratively aluminum tape.

In another advantageous example, the reflective tape, or film, is a dual-mode reflective film developed by SkyCool Systems, Inc., Mountain View, CA, and sold under the registered trademark Skycool. The Skycool® film is highly reflective to sunlight but also emits thermal radiation exceptionally well back into the cold of space through the earth's atmosphere.

Advantageously, this dual-mode film not only reflects sunlight during the day to prevent the underlying surface from heating up but also emits infrared heat to the cold sky, which keeps the panels and any fluid flowing in them, such as PCM, cool. This technology is further described in the following patent publications owned by SkyCool Systems, Inc.: US 2021-0219463 A1; US 2020-0333047 A1; US 2020-0208854 A1; US 2019-0375946 A1; and U.S. Pat. No. 7,503,971 B2.

Retrofit window units incorporating a reflective tape or film on the exterior-facing side of the louvers will not comply with building codes if the tape or film is too shiny. The application of a thin spectrally selective coating, illustratively less than 5 mils in thickness, on the shiny surface of the tape or film solves this problem. As an example, the diffuse spectrally selective coating can be a clear polymer incorporating TiOₓ and may further incorporate, in preferred embodiments, microbubbles or other fillers, such as glass spheres, to produce a matte finish. The coating is preferably applied by an electrostatic spray or air sprayer.

Experiments were conducted to confirm that the application of a diffuse coating to the reflective tape or film does not interfere with the reflective properties of the Al tape or Skycool® film.

Further efficiency can be gained by dynamic shading with the thermal storage technology disclosed herein by incorporating adjustable louver shades, which in some embodiments, are filled with a phase change material (PCM), between the existing glass and the installed WEMS™ unit, for example. In the embodiments incorporating PCM, the PCM adds thermal mass to make the units more effective in both cold and hot weather. This novel system will enhance day lighting, reduce solar heating, improve glare control, improve insulation in cold weather, reduce sensible heat gain in hot weather, and manage heat gain caused by absorbed solar radiance, and enable load shifting and shedding.

The use of louvers to redirect light as well as the use of PCM-filled louvers for thermal storage of heat is well known in the art. The use of a dynamic glazing to manage heat gain is also known. However, Mackinac has discovered that the use of a phase change material in louvers either alone or in conjunction with the light redirecting coatings disclosed herein, particularly in combination with the low-e coated WEMS™ units, is novel.

### BRIEF DESCRIPTION OF THE DRAWING

Comprehension of the invention is facilitated by reading the following detailed description, in conjunction with the annexed drawing, in which:

FIG. 1 is a perspective view of a pane assembly for a retrofit window insulation system, or WEMS™ unit, in accordance with the present invention;

FIG. 2 is an exploded view of a casing adapted to hold two pane assemblies;

FIG. 3 is a perspective view of a dual pane WEMS™ unit of the type shown in FIG. 2 installed inside the frame of a pre-existing window;

FIG. 4A to 4C are perspective end views of an energy positive WEMS™ unit as installed against an existing window and incorporating PCM-containing slats;

FIG. 5 is a perspective end view of an energy positive WEMS™ unit that incorporates multiple optional features such as a solar cell and battery to operate shading, lighting, and angle of the PCM-filled slats;

FIG. 6 is a photographic representation of a cross-sectional view of an energy positive WEMS™ unit that incorporates a roller shade;

FIG. 7 is a graphical representation of passive heat generation and storage showing temperature gain in ° C. as a function of time for an energy positive WEMS™ unit having PCM-filled louvers and a basic WEMS™ unit;

FIG. 8 shows a cross-sectional view of a hollow louver slat filled with a PCM;

FIG. 9 is a graphical representation of the reflectance and transmittance measurements, [R_{SS},T_{SS}] of a white Solar Shade having a range of openness factors from 1% to 10% as a function of wavelength (nm) measured by a spectophotometer from the UV (190 nm) to NIR (2500 nm) range;

FIG. 10 is a graphical representation of the effective [n,k] of the SS fabrics shown in FIG. 9;

FIG. 11 is a graphical representation of temperatures (° F.) of the components of various configurations of window systems (See, configurations B-E on Table 1) where the solar shade (/SS/) component is a Mermet White solar shade having 1% openness plotted as a function of the position of the components in the window system; and

FIG. 12 is a graphical representation of temperatures (° F.) of the components of various configurations of window systems (See, configurations D and E on Table 1) where the solar shade (/SS/) component is a Mermet tinted solar shade having an openness factor of 5% plotted as a function of the position of the components in the window system.

### DETAILED DESCRIPTION

### Basic WEMS™ Unit

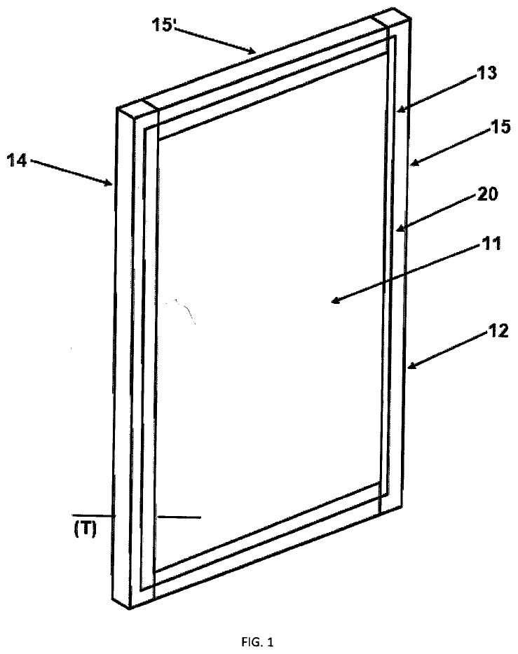

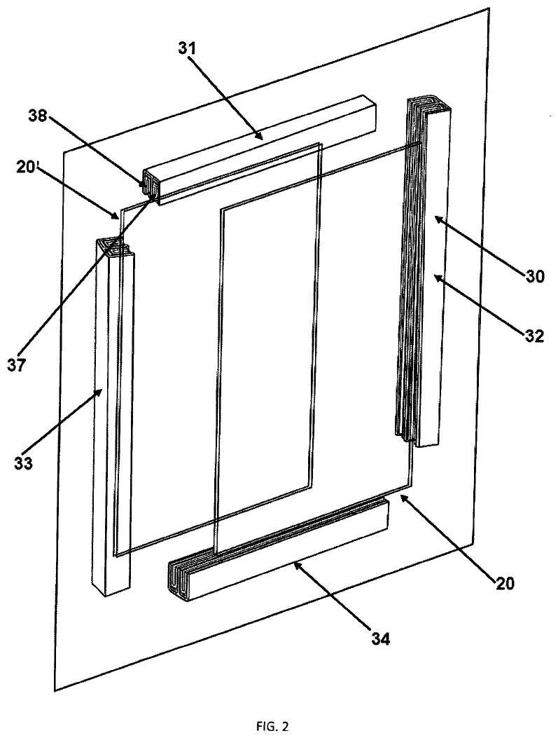

The two primary components of the basic retrofit window insulation system are the pane assembly 20 (FIG. 1) and the casing structure 30 (FIG. 2) which is configured to hold one or more pane assemblies, and in the case of the positive energy WEMS™ units of the instant invention, one or more auxiliary and optional attachments such as louvers and shades.

Referring to FIG. 1, each pane assembly 20 consists, at minimum, of at least one polymer film 11 bonded to a front-facing surface 13 of a rigid frame 12. Rigid frame 12 can be formed of a high strength polymer, illustratively pultruded fiberglass. Frame 12 can also be made of metal, such as a lightweight stainless steel.

Although the frame and casing is custom made for retrofit window insulation system applications, it is typical for rigid frame 12 to be in the shape of a rectangle, that means rigid frame 12 has two pairs of frame profile sections 15, 15′ of unequal lengths that form the rectangle. The frame profile sections have a front-facing surface 13 and back-facing surface 14 and a thickness (t) as measured front to back. Rigid frame 13 is sized to fit within casing structure 30 (see, FIG. 2) or to be directly attached to a pre-existing window frame or surrounding wall in any manner known to those of skill in the art such as by press fit or preferably by releaseable or permanent fasteners.

A second polymer film (not shown in FIG. 1) can be bonded to the rear-facing surface 14 of rigid frame 12. The thickness (t) of rigid frame 12 advantageously separates the two films to form an air gap. If more than two films are desired, more than one pane assembly 20 can be stacked and fastened together. Again, the thicknesses of the rigid frames form an air gap between the films in adjacent pane assemblies. For optimal thermal performance, the preferred air gap width is between about 19 mm to 23 mm, and most preferably about 21 mm.

FIG. 2 is a fully exploded view of a retrofit window insulation system 10′ showing two pane assemblies 20, 20′ being installed in casing structure 30. Casing structure 30 comprises a horizontal header 31 (top), two vertical supports 32 and 33, and a horizontal support 34 (bottom) which form, in this case, a rectangular structure which supports pane assemblies 20, 20′. The interior surfaces of the aforementioned elements comprising casing structure 30 have grooves 37 and 38 configured to receive the two pane assemblies.

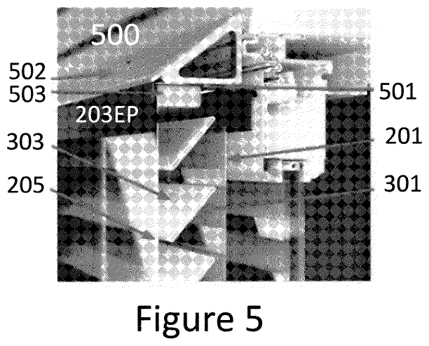

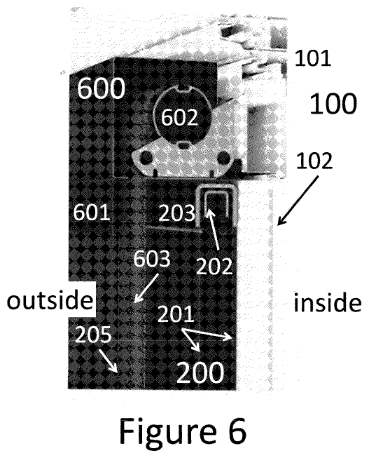

Of course, the casing can be configured to hold more than two pane assemblies by adding grooves. In the alternative, a groove can be wide enough to accommodate more than one pane assembly, using a spacer (not shown in the figures) to separate the pane assemblies to form air gaps. As shown in FIGS. 5 and 6, the casing can be configured to accommodate one or more auxiliary attachments in addition to the pane assembly(ies) resulting in an energy positive WEMS™ unit in accordance with the principles of the present invention.

Further details of exemplary pane assemblies and casings of a basic WEMS™ unit can be found in co-pending U.S. patent application Ser. No. 17/876,999 filed on Jul. 29, 2022, assigned to the Assignee hereof, and published on Mar. 16, 2023 as Publication No. US-2023-0084137, the disclosure of which is incorporated herein by reference.

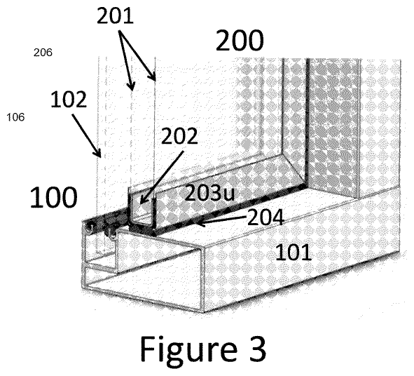

FIG. 3 is a cutaway perspective view of a dual pane WEMS™ unit of the type shown in FIG. 2 that installed inside the frame of a pre-existing window. Referring to FIG. 3, the pane assembly 200 comprises two low-e coated polymer films 201, 201 1 in rigid frame 202 which is in the form of a U-shaped casing structure 203u. Gasket 204 seals the perimeter of the assembly. The pane assembly 200, in this example, is installed on frame 101 of the existing window 100 which is a single pane of glass 102. An air gap 207 is created between the exterior surface 206 of polymer film 201 and the interior surface 106 of window pane glass 102.

The following are examples of polymers that are suitable for use in constructing the panes of a WEMS™ unit of the type used in the practice of the invention. The polymer film(s) provide a substrate for the deposition of a low-e coating which is required to achieve the desired energy performance. As used herein, the term “low-e polymer film” refers to the coated polymer.

The polymer substrate films should have thicknesses that range from 5 mils to greater than 20 mils with low haze (<1%). In preferred embodiments, the polymers are flame-resistant.

The low-e polymer films have a low-e coating, which may be a metal oxide or silver in stacked layers as is known in the art. As used in the examples herein, a low-e coating which is color neutral and achieves greater than 90% visible light transmittance with good low-e performance in the long wave infrared (heat) region was developed by Mackinac,

### TPU

In one example, polymer film 11 (FIG. 1) is a thermoplastic polyurethane (TPU) with an added a low-e coating that is highly reflective to infrared heat energy but is transparent to visible light. TPU is available from commercial suppliers, a specific example of which is Huntsman Corporation, KRYSTALGRAN® PE501-200 DP TPU. Of course, other it is possible to use other polymers, such as polycarbonates or polyesters, such as PET, for the substrate film.

### ETFE

Another polymer film that can be used in the pane assemblies is ETFE which is a copolymer of ethylene and tetrafluoroethylene commonly used in architectural applications and which is also available commercially. As a specific illustrative example, the fluoropolymer film is available from Saint-Gobain Performance Plastics under its mark Chemfilm™ ETFE-E2. Saint-Gobain also supplies an ETFE film with a proprietary “C-treatment” on one side to facilitate adhesion of the film to the rigid frame.

Another example of an ETFE film that is suitable for use in the practice of the present invention is disclosed in co-pending international patent application number PCT/US21/43343, assigned to the Assignee hereof, and laid-open on Dec. 23, 2022 as International Publication No. 2021/258083m the disclosure of which i incorporated herein by reference. This proprietary ETFE film developed by Mackinac has <1% haze, which is lower than standard ETFE which has >10% haze.

### Silicone Rubber

A recent discovery is that the panes can be made from silicone rubber by applying a low-e coating to commercially available transparent, calendared silicone sheets. Low-e coating can be accomplished in a batch-type vacuum deposition machine, or preferably with a semi-continuous high-volume coating machine, as is known to those of skill in the art.

Low e-coating with metal oxides require high-temperature annealing. However, annealing damages a silicone rubber film. We have found that fiber lasers can focus pulses of energy on individual nano layers of the applied coating to create enough oxide to anneal the coating without damaging the silicone substrate.

### Examples of Energy Positive WEMS™ Units

### Louvers

WEMS™ units of the type described hereinabove can be used to make an energy positive WEMS™ unit in accordance with the principles of the invention herein.

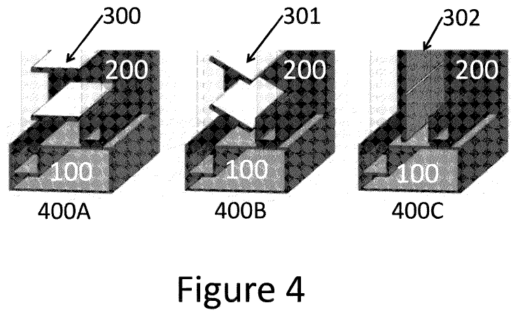

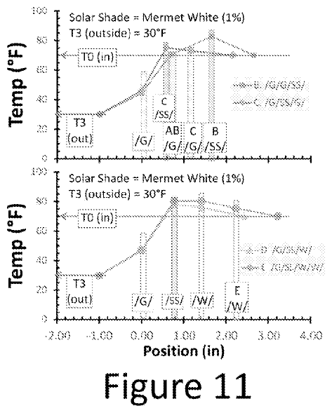

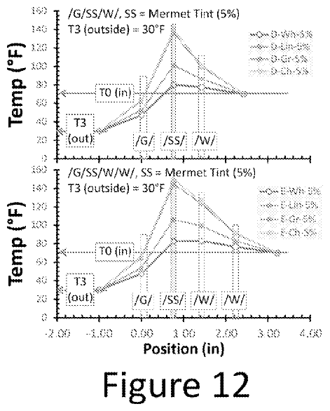

FIG. 4A to FIG. 4C shows perspective cutaway end views of an energy positive WEMS™ unit 400, and more specifically particularly a double pane assembly 200 (see FIG. 3) incorporating two low-e coated silicone rubber panes 201, 201′ in rigid frame 202 as installed in a window frame 100. Louvers 300 which may be filled, in some embodiments, with a PCM (not shown in this figure) are positioned between the existing glass 101 and the installed WEMS™ unit 200. In this example, the energy positive WEMS™ unit 400 is positioned on the interior side of the pre-existing window. There are advantages, as will be evident from the discussion herein relating to FIGS. 11 and 12, to placing the energy positive WEMS™ unit on the exterior side of the pre-existing window.

In this example, louver 300 are “bi-tinted,” meaning that an exterior-facing surface 301, for example, is white or a light tint, and the opposite side of the louver, or interior-facing surface 302 has a dark tint. In operation, the louvers can be tilted by mechanism that are well known. Like a venetian blind, the louvers can be completely retracted to have minimal visual or energy impact on the window, or drawn down and opened at variable angles.

Solar heating and daylighting can be controlled by adjusting the pitch of the louvers. Angling the louvers as shown in FIG. 4A and FIG. 4B will reduce glare and the light-tinted reflecting surfaces of the louvers can function like mini light shelves to redirect sunlight upward to the ceiling for daylighting as shown in mode 400A which is flat, or completely open. In Mode 400B the louvers are angled to reflect or absorb controlled percentages of solar energy impinging on white exterior-facing surface 301. In Mode 400C, the louvers are fully closed to prevent light from entering the interior of the building. This creates an additional pane for maximum thermal insulation and makes the window opaque for privacy and to provide darkness for sleeping.

In advantageous embodiments, the light tinted surfaces 301 are reflective, illustratively made by placing a metal film or tape, such as aluminum tape or Skycool® film on at least the exterior-facing surface. The interior-facing surface 302 can be covered with the same material, or preferably with an absorptive material. Details of spectrally selective surface coatings are described below.

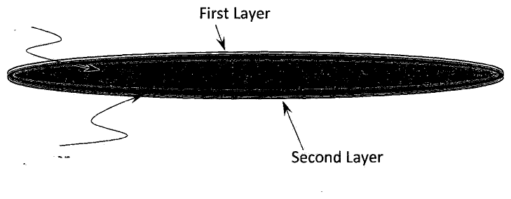

In other advantageous embodiments, the louvers are hollow and filled with a PCM. Referring to FIG. 8, a cross-section of a hollow louver slat 305 shows an elliptical opening 307 that can be filled with a PCM 309. Long hollow louver slats are available commercially. These slats are extruded polycarbonate profiles which are lightweight for compatibility with mechanical systems yet rigid enough to resist deflection if suspended across the width of a window. The hollow louver slats would be sealed to prevent leakage.

Ideally, the PCM filling the louver slats should melt at 27-29° C. and have an energy density of 75 kWh/m³ and 2° C. super cooling. Examples of PCMs suitable for use in the practice of the invention include paraffin wax or organic salt hydrates as known in the art. PCM products are available commercially from Rubitherm GmBH, Berlin, Germany, for example.

Mackinac has developed a proprietary inorganic salt hydrate composite PCM that meets these criteria with excellent thermal reliability. The proprietary Mackinac™ PCM has an energy density of 75 kWh/m3 is suitable for the proposed application as measured data from solar simulation experiments shows that ~5 mm thick Mackinac PCM-filled louvers will reflect most (at least 80%) of the solar irradiance and absorb all of the residual solar heat gain and sensible heat—even on the hottest day in Phoenix, Arizona!

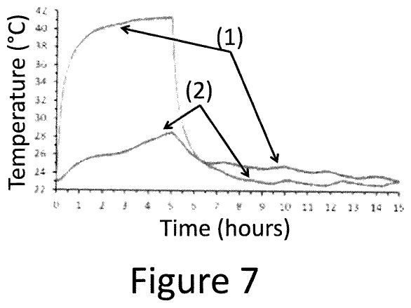

FIG. 7 is a graphical representation showing passive heat generation and thermal storage in ° C. over time as measured in an air gap between an existing window glass and a WEMS™ pane (see, FIG. 3, for example). An energy positive WEMS™ unit employing PCM-filled louvers and a basic WEMS™ unit having no PCM or louvers were heated with a solar lamp for 5 hours to simulate daytime which was then turned off to simulate night. Trace (1) shows the data for the energy positive WEMS™ unit. As shown by Trace (1), the air gap temperature rose to a high of 41° C. and then fell steeply when the heat lamp was turned off at hour 5. The energy positive WEMS™ unit then delivered its stored heat slowly over the next 10 hours. Trace (2) shows the results for the basic WEMS™ unit. In this case, the maximum increase in temperature of the gap was only 5° C. above ambient (~23° C.). By 3 hours after the lamp was shut off, the gap temperature settled back to ambient.

### Spectrally Selective Surfaces

While PCM-filled louvers used in conjunction with a WEMS™ unit produce excellent results as shown in FIG. 8, applying spectrally selective coatings to one, or both, flat planar surfaces of the louvers produces even better results.

Referring to FIG. 4B, for example, the elongated hollow slats 41, 41′ have a top surface 51, 51′ and a bottom surface 52, 52′ which is more clearly shown in FIG. 4D. Top surface 51, 51′ has a specular reflective coating 53 which is on the exterior-facing side of the louver slat. The bottom surface (not clearly shown in this figure) on the interior-facing side is also coated, or covered, in some illustrative examples, with a material 54, that may reflect or diffuse reflection.

In order to be useful in the practice of the invention, the diffuse specular reflective material must reflect 80% of both visible light and near infrared energy (wavelengths of 350-2,500 nm). Of course, the materials, when applied to the louvers, must be aesthetically pleasing and not cause occupant discomfort.

The diffuse specular coating materials are liquid polymers whose optical properties can be tuned by varying the ratios and particle size distribution of fillers, such as titanium dioxide (TiO₂), calcium carbonate (CaCO₃) and various other fillers, pigments, and glass or polymer microbubbles. Different climate zones will require different levels of absorption and heat gain for optimal energy performance.

Examples of diffuse spectrally selective reflective materials that are useful in the practice of the invention are given below.

### Coatings for Louvers/Shades

Reflective coatings for the louvers (or shades) used to control heating of those elements should have low [Aₛₒₗ].

As exemplary coatings, the following materials have [Aₛₒₗ] low enough to render them suitable as a reflective coating. Of course, other coatings that can be purchased commercially or developed in the future, having the requisite properties are within the contemplation of the invention. These illustrative coatings were developed primarily for daytime sky cooling applications. However, their very high [Rₛₒₗ] makes them suited for our low [Aₛₒₗ] solar shading application:
1) a 3M product which uses hollow glass microbubbles as an additive to standard paint formulations (see, Kevin Rink, et al., “Evaluation of glass bubbles for solar heat reflection in waterborne acrylic elastomeric roof coatings,” Coatings Tech, p. 40 (September 2016));
2) a polymer-based hybrid metamaterial with randomly distributed SiO₂ microsphere inclusions developed by U. Colorado researchers (see, Yao Zhai, et al., “Scalable-manufactured randomized glass-polymer hybrid metamaterial for daytime radiative cooling,” Science, Vol. 355, Page 1062-1066 (2017));
3) hierarchically porous poly(vinylidene fluoride-co-hexafluoropropene) (P(VdF-HFP)HP) coatings (which are referred to herein as “F-polymers”), developed by Columbia University researchers (see, J. Mandal, et al., “Hierarchically porous polymer coatings for highly efficient passive daytime radiative cooling,” Science, 10.1126/science.aat9513 (2018); also see Supplementary Materials 10.1126/science.aat9513 (2018); U.S. Pat. No. 10,386,0097 issued Aug. 20, 2019; US Pubn. No. 2018-0180331 laid-open on Jun. 28, 2018; and
4) surface coatings developed by SkyCool Pty Ltd. (See, for example, U.S. Pat. No. 7,503,972 issued Mar. 17, 2009 in the name of Wojtyslak, et al.)

All of these coating are designed to function in the following way:
1) reject as much of the incident solar irradiance as possible in the UV-VIS and NIR wavelengths thereby achieving high “solar reflectance” [Rₛₒₗ] and conversely achieving low solar absorptance [Aₛₒₗ], and
2) increase the thermal emissivity [eₜₕ] as high as possible in the IR wavelengths where the sky is mostly transparent to this IR energy (from about 7 to 14 μm).

By achieving high [Rₛₒₗ], the coating prevents the louver/shade from being heated by solar exposure during the daytime due to its low [Aₛₒₗ] performance. By achieving high [eₜₕ], the coating can effectively cool below ambient air temperatures because the temperature of the sky's thermal radiation, at these infrared (IR) wavelengths, is significantly lower than the air temperature. Thus, the coating strongly emits energy, but receives little in return from the sky. Therefore, with less solar heating, and more thermal emission than it received from the sky, these coatings are achieve passive cooling of surfaces even when exposed to solar radiation during the daytime.

### Solar Shading Fabrics

In addition to louvers, another option that may be incorporated into the energy positive WEMS™ unit is solar shading fabrics which, in typical implementations, are roller blinds. Solar shading fabrics are see-through fabrics which are commercially available and come in a wide variety of colors and open weaves which allows greater visibility to the outside world. The open weaves have, what is referred to herein as an “openness” factor ranging, for example, from 1% to 10%. Typical solar shading fabric is available in colors, which may vary from very white to a very dark charcoal, for example, meant to serve customer aesthetic preferences. In most configurations, roller blinds or shades are pulled down from top to bottom using roller shade mechanisms as are well known in the art.

Examples of solar shading fabrics that can be used in the practice of the invention, are glass/vinyl composites and can specifically include solar shading fabrics sold by Phifer Incorporated, Tuscaloosa, AL; Mermet USA, Cowpens, SC; and Rollease Acmeda/USA Division, Stamford, CT. Extensive measurements, testing and modeling of these solar shading fabrics have been done in order to integrate these solar shading fabrics into the energy positive WEMS™ units of the present invention to achieve the desired energy-related goals of the end product.

The foregoing examples are illustrative and any SS fabric that has these features can be used in the practice of the invention.

The metric that quantifies how much of the irradiance from the sun shining on the outside of a window is transported through the window into the interior space of the building is the solar heat gain coefficient (SHGC). The total solar heating (SHₜ), which defines SHGC, is the sum of two components:

$${SH}_{t} = {SH}_{1} + {SH}_{2} \qquad ( 1 )$$

where SH₁ is the solar energy that indirectly makes its way into the interior space of the building through absorption of solar energy by all envelope items (e.g., wall, roofs, etc.) and SH₂ relates to the direct transmission of solar energy through the envelope items that are transparent, specifically the windows.

Different solar shading materials have different dependencies on the indirect and direct components of solar heating so that the dominant component can change depending on the absorption properties of the materials. While it may seem obvious that dark colored materials/fabrics heat up more than light colored materials, the real question is whether that heat makes it into the room's interior space or not. This non-intuitive aspect depends on the particular design of the window/shading system. The solar shading strategy and design of the present invention enables dynamic control of how and where the heat energy goes. Even using existing commercially-procurable shading fabrics, the system of the present invention has achieved unprecedentedly low SHGC values thereby allowing for strong reductions of AC energy to shed the demand load.

To quantify these SH processes, we begin with focusing on the solar shading fabric itself. We have conducted extensive testing of the Mermet fabrics. These fabrics have a wide range of colors from white to very dark charcoal, and openness factors ranging from 1% to 10%. We will show that the fabrics do not have the superior very high solar reflectance and very low solar absorptance [Rₛₒₗ, Aₛₒₗ] of the daylight cooling materials, or reflective coatings, discussed hereinabove.

In order to evaluate the suitability of solar shading fabrics for use in the invention, we start by making reflectance and transmittance [R_{SS},T_{SS}] measurements of the solar shading fabrics. Using methods established by David V. Tsu, “Obtaining optical constants of thin GeₓSb_{y}Te_{z} films from measurements of reflection and transmission”, J. Vac. Sci. Technol. A, Vol. 17, No. 4, p. 1854 (1999), the disclosure of which is incorporated herein by reference, we numerically solve for the effective optical constants as represented by the refractive index (n) and the extinction coefficient (k). With these [n, k] values, we can model the solar shades like any other optical panel and insert the shade in a variety of positions within the wider window system to determine the window system's [R_{W},T_{W},A_{W}]. The wider window system is defined as the existing window plus an energy positive WEMS™ unit.

This then allows us to compute a variety of metrics important to the window profession, including the visible “VIS” reflectance and transmittance [Rᵥᵢₛ,Tᵥᵢₛ] that is the [R_{W},T_{W}] weighted by the human vision response, as well as the aforementioned [Rₛₒₗ,Tₛₒₗ,Aₛₒₗ] quantities that take the [R_{W},T_{W}] and weight them by the 1.5 airmass (AM1.5) solar spectrum.

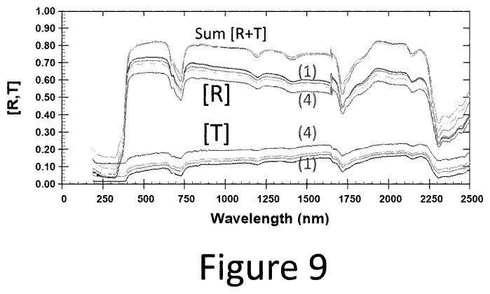

FIG. 9 shows the [R_{SS},T_{SS}] measurements of the Mermet “White” solar shading fabrics for a range of openness factors from 1% (trace 1) to 10% (trace 4), with openness factors 3% and 5% lying in between. As the openness increases, [R] falls and [T] rises. In these White fabrics, the sum [R+T] signals are all virtually the same, near 0.80. Now since the absorptance [A] is defined as

$$A = 1 - ( R + T ) \qquad ( 2 )$$

when the sum [R+T]=0.80, the absorptance=0.20. This absorptance is not particularly low compared to the daytime cooling materials, or aforementioned coatings, discussed hereinabove.

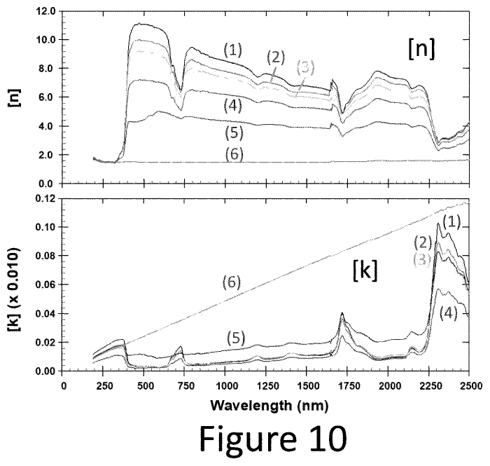

FIG. 10 shows the effective [n,k] of the Mermet Solar shading fabrics, where the high [R_{SS}] of the White (1%) above 0.70 translates into a very high effective [n] above 11.0. As the openness increases, [n] reduces, see trace (4) for White (10%) where [n] is above 7.0. Tinting the fabrics lowers [n] even more. Trace (5) for Linen colored fabric (e.g, buff or ecru) with an openness of 5% has [n] near 5.0 and the very dark Charcoal with an openness of 5%, shown as trace (6), has [n] below 2.0. For the extinction coefficient, White fabric shows a weak increases in [k] as the openness increases, but then [k] notably increases for Linen (5), and strongly increases for Charcoal (5%).

Now that we have the effective [n,k] for the Solar shading fabrics being evaluated, we can assemble the Solar shading into a variety of complete window configurations, where the pre-existing glass panel is designated as /G/, the WEMS™ unit panel as /W/, and the solar shade as /SS/. We have examined various configurations A-E: as described in Table 1.

TABLE 1

| | | |
|---|---|---|
| A | [outside air/G/G/inside air] | standard dual pane window (prior art) |
| B | [outside air/G/G/SS/inside air] | standard shade implementation (prior art) |
| C | [outside air/G/SS/G/inside air] | non-standard SS between glass (prior art) |
| D | [outside air/G/SS/W/inside air] | WEMS ™ unit with 1 panel between SS and |
| | | inside air |
| E | [outside air/G/SS/W/W/inside air] | WEMS ™ unit with 2 panels between SS and |
| | | inside air |

As will become evident from the data presented below, these solar fabrics can be used within the positive energy WEMS™ system of the present invention irrespective of their higher [Aₛₒₗ] characteristics.

With the optical calculations yielding the total [Rₜ,Tₜ, Aₜ,A₍ⱼ₎] where A₍ⱼ₎ is the absorptance of each (j) panel, a full thermal/optical energy calculation determines first how much heating each panel experiences, then determines how this heat passes either to the outside or inside environments.

The following tables, show the computed [Rₛₒₗ,Tₛₒₗ,Aₛₒₗ] values, where [Aₛₒₗ] represents the combined absorptance of all panels, i.e., from [Aₜ].

Referring to Table 2, the fraction of [Aₛₒₗ] that flows to the inside of the building, is designated as “fAₛₒₗ_IN.” SH_1 equals the actual absorbed solar energy that makes it into the inside herein designated as “Aₛₒₗ_IN”. The SH_2 component is simply equal to [Tₛₒₗ] and the sum of the SH_x components, and SH_t, represents the SHGC.

TABLE 2

| | [symbol] Solar Shade | | Solar | | | [symbol] tion of | SH [symbol] 1 | SH [symbol] 2 | SH [symbol] |
|---|---|---|---|---|---|---|---|---|---|
| Configuration | Color | Openness | [Rₛₒₗ] | [Tₛₒₗ] | [Aₛₒₗ] | fAₛₒₗ_{_{—}}IN | Aₛₒₗ [symbol] IN | [Tₛₒₗ] | SHGC |
| D. /G/SS/W/ | White | 1% | 0.588 | 0.065 | 0.347 | 0.244 | 0.085 | 0.065 | 0.150 |
| | White | 5% | 0.555 | 0.083 | 0.362 | 0.252 | 0.091 | 0.083 | 0.174 |
| | Linen | 5% | 0.389 | 0.087 | 0.525 | 0.266 | 0.140 | 0.087 | 0.226 |
| | Grey | 5% | 0.140 | 0.037 | 0.823 | 0.259 | 0.213 | 0.037 | 0.250 |
| | Charcoal | 5% | 0.109 | 0.029 | 0.862 | 0.259 | 0.223 | 0.029 | 0.252 |
| E. /G/SS/W/W/ | White | 1% | 0.587 | 0.057 | 0.357 | 0.169 | 0.060 | 0.057 | 0.117 |
| | White | 5% | 0.554 | 0.073 | 0.373 | 0.177 | 0.066 | 0.073 | 0.139 |
| | Linen | 5% | 0.389 | 0.075 | 0.536 | 0.181 | 0.097 | 0.075 | 0.172 |
| | Grey | 5% | 0.141 | 0.031 | 0.828 | 0.172 | 0.142 | 0.031 | 0.173 |
| | Charcoal | 5% | 0.109 | 0.024 | 0.867 | 0.171 | 0.148 | 0.024 | 0.172 |

[symbol]

indicates data missing or illegible when filed

Table 2 shows the solar performance for Mermet White fabric with (1%) openness in Configurations A through E as more fully described in Table 1A. For reference, standard dual glass pane window (Configuration A), the fraction of [Aₛₒₗ] that flows to the inside (as fAₛₒₗ_IN) is only 0.356, or about ⅓ of the total absorbed solar energy. The reason that this fraction is less than half (0.50) is that the outside environment has forced convection (i.e., wind) and the inside environment has only natural convection. Values of about ⅓ for fAₛₒₗ_IN is representative of symmetrical or balanced “thermal stacks” in the presence of forced convection. Now, since [Aₛₒₗ] for this configuration is comparatively small (0.130), the actual absorbed energy component SH_1 that flows to the inside air is only 0.046 whereas the direct component SH_2, [Tₛₒₗ], is 0.734, making the direct component at 94% the overwhelmingly dominant portion of the total SHGC.

A standard shade implementation, that is, a standard dual pane window with a fabric shade in front (Configuration B; /G/G/SS/) slows the heat flow to the outside, so that fAₛₒₗ_IN is a more balanced 0.495. In other words, this configuration creates an unbalanced thermal stack that counteracts the effects of forced convection in the outside environment where the high [Aₛₒₗ] absorption is directly adjacent to the inside environment. So now, the SH_1 dominates over SH_2, where SH_1 accounts for 73% of the SHGC (SH_t). Even though [Aₛₒₗ] of 0.391 is much larger than that of Configuration A, the fact that [Rₛₒₗ] has increased to 0.537 is a principal reason why Configuration A has a lower SH_t of 0.265.

In Configuration C, which is a known, but non-standard configuration where the solar shade in inserted between two glass panes, the [Rₛₒₗ,Tₛₒₗ,Aₛₒₗ] values are nearly the same as in Configuration B. However, in Configuration C, the thermal stack is once again symmetric so that the fraction fAₛₒₗ_IN at 0.326 returns to the value of about ⅓ of Configuration A. This explains the drop in SH_t to 0.186 for this embodiment.

Configurations D and E, are exemplary of the present invention which comprises, in some cases, the use of one or more low-e WEMS™ panels to construct a highly asymmetrical thermal environment by using its low-e surface properties to act as a shield to prevent the heat produced within the Solar shading fabric from flowing back into the inside environment. As will be seen from the data presented herein, it is possible to achieve a low SHGC value, for example, 0.117 for Configuration E even with Solar shading material that is strongly sub-optimal because it has a high [Aₛₒₗ] of 0.20.

With the WEMS™ panels as incorporated into Configurations D and E, [Rₛₒₗ,Tₛₒₗ,Aₛₒₗ] values are nearly the same as in Configurations B and C, however, the imbalance of the thermal stack is even more pronounced. The result is that in Configuration E, for example, fAₛₒₗ_IN is only 0.169. Now, with the final [Aₛₒₗ_IN] (SH_1 in Table 1B) at a very low 0.60, which is similar to the Tₛₒₗ(SH_2 in Table 1B) of 0.057, the SHGC (SH_t) is very low at only 0.117. The SH_1 and SH_2 components contribute a nearly equal amount [51%, 49%] of the total SHGC.

The data in Table 2 demonstrates the advantageous protective effect of high solar absorptance. Referring to Table 2, Solar shading fabric, having non-white tints, as offered by Mermet, are used in the inventive configurations, D and E. When we compare the White (1%) vs. White (5%), the main reason for the small increase in SH_t relates to the higher [Tₛₒₗ] that occurs naturally when there is more void gaps (i.e., openness) through which light can pass unhindered.

As shown in Table 3, as the tinting level increases, there is an increase in SH_1 which is substantially offset by a decrease in SH_2 [Tₛₒₗ] so that the final SH_t only increases slightly. For Configuration E, the [Aₛₒₗ] grows enormously for the Charcoal tint by 2.3× (or 230%) above the [Aₛₒₗ] of White (both 5%), however, the increase in SH_t for the Charcoal tint is only 1.24× (or 24%) above the [Aₛₒₗ].

TABLE 3

| | [symbol] Solar Shade | | Solar | | | [symbol] tion of | SH [symbol] 1 | SH [symbol] 2 | SH [symbol] |
|---|---|---|---|---|---|---|---|---|---|
| Configuration | Color | Openness | [Rₛₒₗ] | [Tₛₒₗ] | [Aₛₒₗ] | fAₛₒₗ_{_{—}}IN | Aₛₒₗ [symbol] IN | [Tₛₒₗ] | SHGC |
| A. /G/G/ | | | 0.136 | 0.734 | 0.130 | 0.356 | 0.046 | 0.734 | 0.780 |
| B. /G/G/SS/ | White | 1.0% | 0.537 | 0.072 | 0.391 | 0.495 | 0.194 | 0.072 | 0.265 |
| C. /G/SS/G/ | | | 0.586 | 0.075 | 0.340 | 0.326 | 0.111 | 0.075 | 0.186 |
| D. /G/SS/W/ | | | 0.588 | 0.065 | 0.347 | 0.244 | 0.085 | 0.065 | 0.150 |
| E. /G/SS/W/W/ | | | 0.587 | 0.057 | 0.357 | 0.169 | 0.060 | 0.057 | 0.117 |

[symbol]

indicates data missing or illegible when filed

The data in Table 3 demonstrates that the configurations devised in accordance with the present invention can corral the heat produced by absorptive solar shading, using the low-e WEMS™ panels, to constrain a high fraction of solar heat to the outside environment. This naturally lowers the load on the HVAC system of the building by enhancing the load shedding.

In addition to solar shading fabric, which can be incorporated into the window system as a roller shade, for example, or as a honeycomb shade, other examples of energy positive WEMS™ units can be devised within the principles of the invention. Of course, the use of louvers, and in particular, louvers incorporating PCMs is advantageous for shading control. The louvers and be installed horizontally, as in venetian blinds, or vertically as is known in the art. Energy efficiency can be further increased by providing the louvers with coatings and tints, as described hereinabove, that in some examples, can differ on each side to affect the operation and function of PCM thermal storage and release.

FIG. 5 is a perspective end view of an energy positive WEMS™ unit 500 that incorporates multiple optional features such as solar cell 502 which charges battery 503 which is used to power shading, lighting, and the controls for tilting the PCM-filled louver slats 303. In FIG. 5, the energy positive WEMS™ unit 500 is installed on the exterior of the building in front of a pre-existing window glass 101. Casing 30 supports the elements of positive energy WEMS™ unit 500, which are specifically, solar cell 502, LED 501, the mechanism (not shown) for raising and lowering the louvers and tilting them on an angle so that the exterior-facing surface(s) 301 of the louvers can direct solar light as desired. Casing 30 also holds a first pane assembly 200 comprising low-e polymer film 201 in rigid frame 203 between the existing window glass 101 and the PCM-filled louvers 303. A second, external pane (EP) assembly comprising polymer film 205 in rigid frame 203EP is on the exterior of the unit and serves to protect the internal elements from wind and weather.

Another advantageous option to the energy positive WEMS™ unit of the present invention is the addition of a sound-absorbing. As an example, a mineral wool or other fibrous insulating material, such as a commercially available product sold under the trademark Sonozorb by GDC, Inc., Goshen, IN. Sonozorb™ insulation is a light-weight, durable, high-loft polypropylene acoustic insulation that creates an torturous path for sound waves. It can be used in the casing (e.g., casing 30 in FIG. 2) that holds a WEMS™ pane assembly (e.g., pane assembly 20, FIG. 1) in place to damp sound. Of course, other products are available and, in some instances, are suitable to use as a film on the interior-facing surface of a louver (e.g., interior-facing surface 302, FIG. 4C).

FIG. 6 is a photographic representation of a cross-sectional view of an energy positive WEMS™ unit 600 that incorporates a roller shade. In this figure, the energy positive WEMS™ unit 600 is installed on the exterior window frame 101 of the existing window 100 which is a single pane of glass 102. Referring to FIG. 6, the roller shade comprises a cover (or header) 601 for the roller mechanism 602 and shading fabric 603, which in this example is a tinted shading fabric having some openness. Pane assembly 200 comprises a first pane assembly of low-e polymer films 201 in rigid frame 203 which lies between the existing window glass 102 and the roller shade fabric 603. A second external pane (EP) assembly holds polymer film 205 in rigid frame 203EP to protect the internal elements against the wind and weather.

Of course air gaps are formed between all of the element of the energy positive WEMS™ unit 600 and the external surface 108 of window glass 102.

The mechanisms for retracting and lowering the slats is disposed in the header of the WEMS™ unit and can be any manual mechanism as is known in the art. For example, the manual mechanism for raising and lowering venetian blinds wherein the long slats are held together by a string and raised and lowered by pulling another string and opened and closed by rotating a rod or pulling another string. Likewise, the mechanism for retracting and lowering a fabric solar shade, such as a the mechanisms for a roller shade (e.g., 602), is disposed in the header of the WEMS™ unit. Of course, these all of these mechanisms can be electrically controlled as is known in the art.

The energy positive WEMS™ units of the present invention can be installed against the preexisting window (i.e., inside the window frame) or on the wall so that there is an air gap between the WEMS™ unit and the window. Of course, the WEMS™ unit can be installed on the exterior of the building too. In the case of casement windows, or tilt-and-turn windows, the WEMS™ unit can be attached to the window frame so that it moves with the window. For double or single hung windows, a vertical lift mechanism can stack a lower WEMS™ unit over an upper WEMS™ unit. Of course, the WEMS™ unit can be adapted to work with a sliding door. In view of the foregoing, it is obvious that the energy positive WEMS™ units of the present invention can be adapted to work with any preexisting window/door configuration that is now known, or becomes known.

The superior results achievable with the energy positive WEMS™ unit of the present invention is shown in Table 4 which compares its efficiency with some known prior art secondary attachments, or retrofit window insulation systems.

TABLE 4

| | | Dynamic | Gas | Imperial units | | Heat [symbol] | | | [symbol] | [symbol] |
|---|---|---|---|---|---|---|---|---|---|---|
| Product | I [symbol] ts | Shading | [symbol] | R [symbol] value | [symbol] value | reduction | SHGC | VT | weight [symbol] (lb) | per ft [symbol] |
| | Single-pane | | Air | 0.99 | 1.01 | — | 0.81 | 0.844 | — | — |
| | glass Baseline | | | | | | | | | |
| | +Winsert Lite | | Air | 1.87 | 0.54 | 47% | 0.70 | 0.727 | 20 | $18.15 |
| | +Winsert Plus | | Air | 4.30 | 0.23 | 77% | 0.42 | 0.577 | 50 | $23.15 |
| | +1x WEMS ™ | | Air | 3.73 | 0.27 | 73% | 0.77 | 0.843 | 14 | $15.00 |
| | +2x WEMS ™ | | Air | 6.29 | 0.16 | 84% | 0.69 | 0.807 | 18 | $20.00 |
| | +3x WEMS ™ | Open | Air | 8.79 | 0.11 | 89% | 0.64 | 0.754 | 40 | $35.00 |
| | | Closed | | | | | 0.05 | 0.000 | | |
| | Std. Dual-pane | | Air | 2.08 | 0.48 | 52% | 0.78 | 0.820 | 126 | $41.00 |
| | glass Baseline | | | | | | | | | |
| | +1x WEMS ™ | | Air | 4.81 | 0.21 | 79% | 0.70 | 0.770 | 14 | $15.00 |
| | +2x WEMS ™ | | Air | 7.35 | 0.14 | 87% | 0.63 | 0.737 | 18 | $20.00 |
| Cardinal LoE²-272 | | | Argon | 5.88 | 0.17 | 83% | 0.37 | 0.630 | | |
| Cardinal LoE³-366 | | | Argon | 4.17 | 0.24 | 76% | 0.27 | 0.650 | | |
| | Std. Triple-pane | | Air | 2.86 | 0.35 | 65% | 0.70 | 0.750 | 182 | $51.00 |
| | glass Baseline | | | | | | | | | |
| Cardinal LoE²- | | | Argon | 5.88 | 0.17 | 83% | 0.37 | 0.630 | | |
| 272/C/-LoE-180 | | | | | | | | | | |
| Cardinal LoE²- | | | Argon | 5.88 | 0.17 | 83% | 0.25 | 0.570 | | |
| 366/C/-LoE-181 | | | | | | | | | | |

Winsert Lite ™ and Winsert Plus ™ are high performance, secondary interior window inserts available from Alpen High Performance Products, Louisville, CO. (See, www.thinkalpen.com); https://thinkalpen.com/wp-content/uploads/2021/01/WinSert-Information-Sheet-2020-12-v1.pdf Cardinal LoE glass is available from Climate Guard Windows & Doors, Chicago, IL. [symbol]
indicates data missing or illegible when filed

### Controlling Temperature Distribution

The positive energy WEMS™ unit is a part of, what is described herein, as a “positive energy window system.” The arrangement of the glass/solar shading/WEMS™ units in the positive energy window system enables allows control of the temperatures of internal components within the system, such as the phase change materials, so that they function more reliably to store and release thermal energy.

This positive energy window system comprises a mix of uncoated panels (typically glass panes (/G/) that are pre-existing; solar shade panels (/SS/) of different tinting and openness factors, or louvers (also /SS/) and the low-e coated panels in the WEMS™ units (/W/). In accordance with the invention, the solar heating effects, even for very dark tinted (e.g., charcoal tinted) roller shade fabric are substantially decoupled from the solar heat gain coefficient (SHGC). For example, with White solar shade fabric, the measured temperature of the /SS/panels can be 83° F. under 500 W/m² solar irradiance whereas for the dark charcoal solar shade fabric under the same irradiance, the temperature is 150° F., yet the difference in their respective SHGC values only increases modestly from 0.11 to 0.17.

Control of the distribution of temperatures within the components of the positive energy window system allows regions within the system to do work, in a general sense, the work may include mechanical, electrical, or chemical actions. The key to allowing for such action is to control the distribution of temperatures within the system so as to create a specific, or selected regions, having elevated temperatures that we control. For example, an actor such as a PCM, placed within a selected region, undergoes a chemical phase change reaction to absorb thermal heat energy while under solar illumination and then to release that heat at a later time as the temperature drops. Without establishing the special temperature conditions within this selected region, control of the PCM would be by happenstance.

FIG. 11 is a graphical representation that shows the temperature distribution for the configurations shown in Table 1. In FIG. 11, the solar shading, /SS/ is Mermet White having an openness factor of 1%. The environmental conditions for these calculations are: inside/outside air temperatures=T0/T3=70° F./30° F.; wind speed=10 Mph; and the solar irradiance incident onto the window's outside surface (#1)=500 W/m². The temperature of the components in ° F. is plotted against the position of the components in inches from the outside surface #1 of the first /G/panel which defines the origin at position 0.0 inch. The position of T3 is set at −1.0 in and the position of T0 is set at +1.0 (in) beyond the final window surface. The gap temperatures would be the average between the temperatures of two adjacent components.

Referring to FIG. 11, configuration B (/G/G/SS/), which is a standard shade implementation where the /SS/ is the inside-most element, is shown in orange.

Configuration 1 has the highest temperature of 83° F. Generally speaking, the temperatures out to T3 monotonically decrease and have a similar magnitude of slope as they decrease to T0. This means that by this visual depiction, roughly half the absorbed solar energy that heats the /SS/ panel flows to the outside/inside environments.

Configuration C (/G/SS/G/), shown in blue, has the solar shade between two glass panes, an has a temperature of 75° F. which is somewhat lower than the temperature of the solar shade in configuration B because there is only one glass pane blocking the heat flow to the outside. The second glass pane also blocks solar shade heat flow to the inside. In FIG. 11, its slope has substantially flattened, so that now, 32% of its heat flows to the inside environment.

Configurations D and E represent energy positive WEMS™ units in accordance with the present invention. In configuration D, the one low-e panel /W/ is more effective in trapping the solar shade heat compared to the second glass pane of configuration C. The solar shade temperature of configuration D reaches 78.2° F., where 22% of its absorbed heat flows into the inside environment.

Adding a second low-e panel in configuration E further increases the solar shade temperature to 80.5° F., but now only 16% of its absorbed energy makes it to the inside environment.

FIG. 12 is a graphical representation of temperatures (° F.) of configurations D and E on Table 1 where the solar shade (/SS/) component is a Mermet tinted solar shade having an openness factor of 5% plotted as a function of the position of the components of the configurations in the window system. The various tinting options are described in Table 2. Generally, as the tint of the solar shade darkens, the absorbed heat increases and so the solar shade temperature increases. This is demonstrated in FIG. 12 where in configuration D, which has only one WEMS™ unit panel /W/ to trap the heat from flowing into the inside environment, the White solar shade increases to 80.0° F. while the Charcoal shade increases to 140° F. In this comparison, the total solar absorptance [Aₛₒₗ] using the White panel is 36.2%, where the fraction of this that makes it to the inside environment is 22.8%, yielding a total fraction of the absorbed incident solar irradiance 8.2%, i.e., SH_1=0.082. For the Charcoal tint, [Aₛₒₗ] is a much higher 86.2%, and the fraction of this that makes it to the inside environment is only slightly higher at 26.0%, yielding a total fraction of the absorbed incident solar irradiance 22.4%, i.e., SH_1=0.224.

Configuration E has two WEMS™ unit panels to block heat from flowing to the inside environment. The temperature of a White solar shade increases to 83.0° F. and the Charcoal shade increases to 149.5° F. but SH_1 drops to 0.061 and 0.144, respectively.

The temperature plots shown in FIGS. 11 and 12, convey only the effects of the Type-1 SH_1 indirect solar heating. While SH_1 increases as the tint of the solar shade darkens, the direct SH_2 components decreases with increasing darkening. Thus, even with the darkest Charcoal tint, the total SH_t can still be maintained below 0.17. Therefore, shade tint can effectively be separated from the question of SHGC. This demonstrates that the energy positive WEMS™ units of the present invention, when incorporated into a window system, can control the temperature in selected regions of the window system.

Although the invention has been described in terms of specific embodiments and applications, persons skilled in the art can, in light of this teaching, generate additional embodiments without exceeding the scope or departing from the spirit of the claimed invention. Accordingly, it is to be understood that the drawing and description in this disclosure are proffered to facilitate comprehension of the invention, and should not be construed to limit the scope thereof. Moreover, the technical effects and technical problems in the specification are exemplary and are not limiting. The embodiments described in the specification may have other technical effects and can solve other technical problems.

1. A retrofit window insulation system for an existing window frame or surrounding wall structure comprising:
at least one pane assembly, said at least one pane assembly having
a rigid frame structure with a front surface and a back surface and a thickness (t) as measured front to back, and
at least one low-e coated polymer film bonded to the front surface of the rigid frame structure.

2. The retrofit window insulation system of claim 1 further comprising
a casing structure, said casing structure being configured to hold one or more pane assemblies and to be attachable to the existing window frame or a surrounding wall.

3. The retrofit window insulation system of claim 1 wherein there are two low-e coated polymer films bonded to the rigid frame structure, the second low-e-coated polymer film being bonded to the back surface of the rigid frame structure and the thickness (t) defining an air gap between the two low-e coated polymer films.

4. The retrofit window insulation system of claim 1 wherein the low-e coated polymer film has as low-e coating on both sides.

5. The retrofit window insulation system of claim 2 wherein said casing structure further is adapted to support elements of a decorative and/or a functional nature.

6. The retrofit window insulation system of claim 5 wherein the elements of a decorative and/or functional nature are selected from the group consisting of louvers, solar shades, blinds, or light shelves.

7. The retrofit window insulation system of claim 6 wherein the element of a decorative and/or functional nature is louvers having a profile that has a cavity which is filled with a phase change material, the profile of the louvers having an exterior-facing surface and an interior-facing surface.

8. The retrofit window insulation system of claim 7 wherein at least one of the exterior-facing surface and interior-facing surface has a reflective coating or covering.

9. The retrofit window insulation system of claim 8 wherein the reflective coating is on the exterior-facing surface and the coating or covering is a metallized tape which further includes a diffuse coating or covering.

10. The retrofit window insulation system of claim 9 wherein the diffuse coating or covering is a polymer composite that can be tuned by varying the ratios and particle size distribution of fillers, such as titanium dioxide (TiO₂), calcium carbonate (CaCO₃), pigments, and glass or polymer microbubbles.

11. The retrofit window insulation system of claim 8 wherein the interior-facing surface is coated or covered with an absorbing material to create solar heating that can be stored in said PCM.

12. The retrofit window insulation system of claim 11 wherein the absorbing material is fabric, wood veneer, or a darker tinted coating.

13. A retrofit window insulation system for an existing window frame or surrounding wall structure comprising:
at least one pane assembly, said at least one pane assembly having
a rigid frame structure with a front surface and a back surface and a thickness (t) as measured front to back, and at least one low-e coated polymer film bonded to the front surface of the rigid frame structure;
a casing structure, said casing structure being configured to hold one or more pane assemblies and a solar shading component, said casing structure being mounted to the window frame so that there is at least one pane assembly between the solar shading component and the inside air.

14. The retrofit window insulation system of claim 3 wherein there are two low-e coated polymer films bonded to the rigid frame structure, the second low-e-coated polymer film being bonded to the back surface of the rigid frame structure and the thickness (t) defining an air gap between the two low-e coated polymer films.
